(19) United States
(12) Patent Application Publication
(10) Pub. No.: US 2004/0153443 A1
(43) Pub. Date: Aug. 5, 2004

(54) Retrospective learning system for generating and retrieving patient records containing physiological data

(76) Inventors: John S. McDonald, Rolling Hills, CA (US); Drew Cheng, Torrance, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/359,663

(22) Filed: Feb. 5, 2003

(51) Int. Cl. G06F 7/00

(52) U.S. Cl. 707/3

(57) ABSTRACT

A retrospective learning system is described for recording physiological conditions of a patient over a period of time and storing such data in a database in searchable format. The retrospective learning system includes a database to store a number of searchable records, each searchable record including data representing a physiological condition of a patient over a period of time. The system further includes a module to retrieve the records from the database based on a search query and to replay selected ones of the retrieve records. In one embodiment, at least a portion of the data included in the patient record is in a waveform format suitable for providing a waveform image. The patient record further includes data corresponding to the waveform data converted into a searchable format.

### BACKGROUND

1. Field

System for storing and replaying of patient data.

2. Background

To keep patients pain-free during medical procedures (e.g., surgery), various forms of anesthesia may be used. While the patient is under anesthesia, a number of monitoring devices and techniques can be employed. The information generated by the monitoring devices may be processed by a physician to ensure the safety of the administration of the anesthesia. For example, a blood pressure machine may be used to measure a blood pressure of a patient at certain intervals while the patient is anesthetized. A pulse oximeter may be used to measure the amount of oxygen in the body of the patient and a pulse rate of the patient. Small electrodes may be placed on the body of the patient and connected to an electrocardiogram (EKG) machine to provide a display of the heart of the patient, tracing on a monitor screen for a physician to observe.

The operating room environment is relatively hostile from the viewpoint of capture, presentation, and movement of data. As a result, when complications occur during a surgery, physicians (e.g., anesthesiologists) who were not present in the operating room will typically not gain any experience from what transpired in the operating room due to its isolation.

### SUMMARY

In one embodiment, a retrospective learning system is provided for recording physiological conditions of a patient over a period of time and storing such data in a database in searchable format. The retrospective learning system includes a database to store a number of searchable records, each searchable record including data representing a physiological condition of a patient over a period of time. The system further includes a module to retrieve the records from the database based on a search query and to replay selected ones of the retrieve records. In one embodiment, at least a portion of the data included in the patient record is in a waveform format suitable for providing a waveform image. The patient record further includes data corresponding to the waveform data converted into a searchable format.

### BRIEF DESCRIPTION OF THE DRAWINGS

Embodiments of the invention may best be understood by referring to the following description and accompanying drawings, in which:

FIG. 1 is a block diagram of one embodiment of a system for storing and replaying patient data.

FIG. 2A is an example of one embodiment of a database containing a number of patient records.

FIG. 2B is an example of another embodiment of a database containing a number of patient records.

FIG. 3 is a flowchart diagram of operations of populating a database with physiological data according to one embodiment.

FIG. 4 is a flowchart diagram of operations involved in retrospective learning process according to one embodiment.

FIG. 5 is an example of analyzing waveform data according to one embodiment.

### DETAILED DESCRIPTION

In the following description, specific details are set forth. However, it is understood that embodiments may be practiced without these specific details. In other instances, well-known software programs, structures and techniques have not been shown in detail in order to avoid obscuring the understanding of this description.

In one embodiment, a retrospective learning system is provided for recordation and presentation of various physiological and pharmacological events so that data from a patient (e.g., data generated during a surgery) can be shared at a later time for the training and education of other physicians. One suitable application for an embodiment of a retrospective learning system is collection (recordation) and presentation of anesthesiology data generated, for example, in a hospital in the context of surgery and before and/or after surgery. In this regard, the following description of an embodiment of a retrospective learning system makes specific references to anesthesiology data and practice. It is appreciated that this embodiment is an example of the utility and implementation of a retrospective learning system and such a system can have application in many other areas where data collection and analysis is performed, including other medical disciplines.

In one embodiment, a retrospective learning system includes a database to store a number of searchable records, each searchable record including data representing a physiological condition of a patient over a period of time (e.g., while the patient is anesthetized), and a module coupled to the database to retrieve records from database based on a search query and to replay selected ones of the retrieved records.

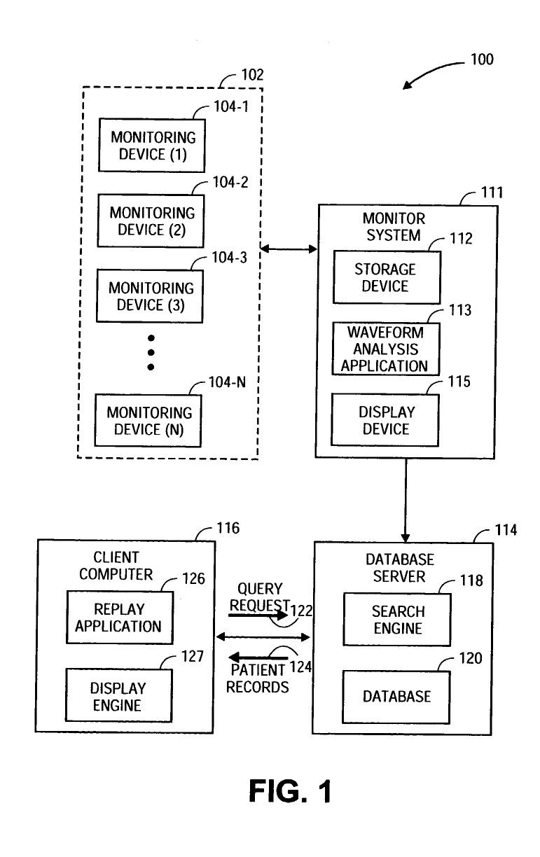

Disclosed in FIG. 1 is retrospective learning system 100 for storing and replaying patient data. Included in retrospective learning system 100 are a number of patient monitoring devices 102 to generate data representing various physiological conditions of a patient over a period of time (e.g., intra-operative anesthetic data). The patient monitoring devices 102 are connected to a patient to measure, for example, heart rate, systolic and diastolic blood pressure, and plethysmographic oxygen saturation. Thus, patient monitoring devices include, monitoring devices 104-1 through 104-N.

In addition to the measurement of heart rate, blood pressure and oxygen saturation levels, the system may also include monitoring devices to collect data on end-tidal CO₂ and anesthetic agent identification and concentration, electrocardiogram (EKG) waveform with ST segment analysis, neuromuscular function (train-of-four and percentage of depression), and the bispectral index (BIS-a process EEG which correlates with anesthetic depth/hypnosis).

As shown in FIG. 1, retrospective learning system 100 further includes a monitor system 111 to receive the data generated by monitoring devices 102. Monitor system 111 may be any computing device capable of performing sequential program execution, including a personal computer. Monitor system 111 may receive physiological data generated by the monitoring devices 102 directly (e.g., via Internet, wired communications network, wireless communication network, etc.) from one or more operating rooms. Alternatively, physiological data generated by monitoring devices 102 can also be received indirectly by monitor system 111. For example, physiological data may be recorded on a machine-readable medium (e.g., read only memory (ROM), random access memory (RAM), magnetic disk storage mediums, optical storage mediums, flash memory devices, etc.) and manually transferred into storage device 112 by a local staff. Other data parameters may also be used.

Included in monitor system 111 is storage device 112 to store data generated by monitoring devices 102 over a period of time. For example, physiological data of a patient may be collected during surgery while the patient is undergoing anesthesia. It should be noted that, typically, during each surgery, there will be an enormous amount of information generated by devices monitoring physiological conditions of a patient.

In addition to the physiological information generated by the patient monitoring devices, retrospective learning system 100 may also include means for storing event information concerning medications that were administered during surgery. The event information may be associated with a time to indicate when such medication was administered. In one embodiment, the manually entered event information along with data generated by patient monitoring devices 102 are stored within the same patient record maintained by database 120.

The data stored in the storage device 112 may be exported to database server 114 to populate database 120 containing other patient records, each patient record including data representing a physiological condition of a patient over a period of time. As this process continues to further populate database 120, data collected from a large number of patients will be maintained within the database server 114. In one aspect, database server 114 provides a tool to organize the information generated by the patient monitoring devices during a large number of surgery cases in a manner which facilitates retrospective learning.

The large collection of patient records stored in database server 114 can be accessed by client computer 116 connected to database server 114. Client computer 116 includes replay application 126 to replay a patient record retrieved from the database server. In one embodiment, replay application 126 running in client computer 116 enables waveforms and numeric data contained in the selected patient record to be replayed on display device 127.

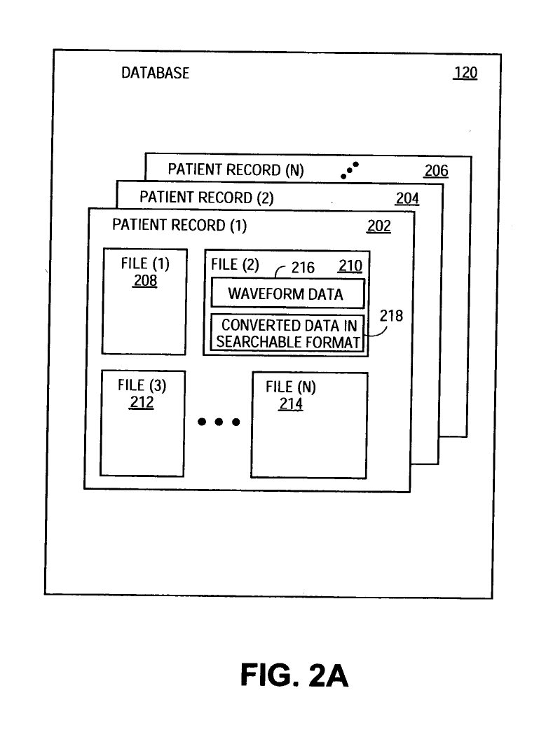

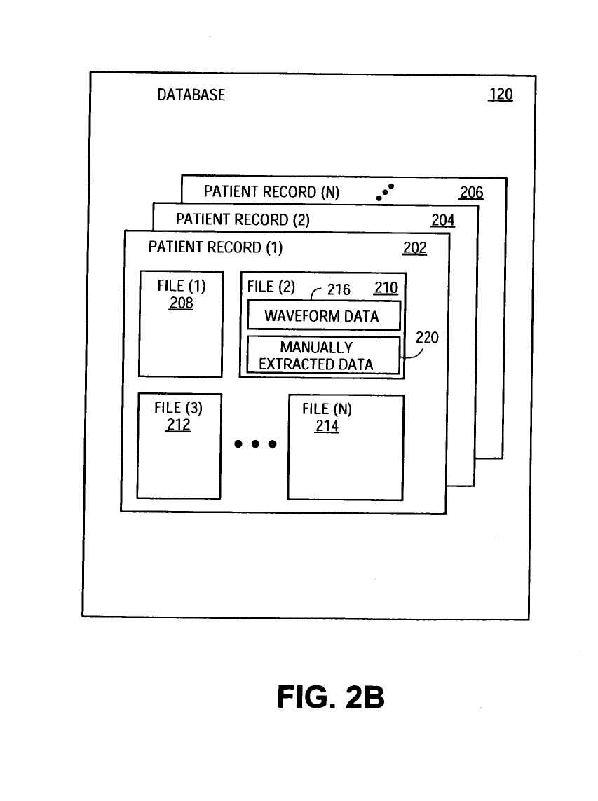

Referring to FIG. 2A, an example of one embodiment of a database 120 containing a number of patient records 202-206 is shown. Patient records 202-206 included in database 120 may be indexed or labeled to associate each of records 202-206 with a particular patient or a particular surgery case. As shown, each patient record includes a number of files 208-214, each file containing data from one of the respective monitoring devices 104-1 through 104-N (shown in FIG. 1). Each patient record may also include information pertinent to the patient or surgery (such as gender, age, allergies, etc.) and maintain such information in a separate file within the record.

The data generated by patient monitoring devices 102 (e.g., monitoring devices 104-1 through 104-N) may be in various formats. A portion of the data in the patient records 202-206 may be in a searchable format (e.g., text format). Other portion of the data may be in a non-searchable format. For example, some of the data generated by the patient monitoring devices 102 may be in a waveform format suitable for providing a waveform image.

In accordance with one aspect, at least a portion of non-searchable data is converted into a searchable format to enable queries to be performed on the converted data. In the embodiment illustrated in FIG. 1, retrospective learning system 100 includes monitor system 11 in which a waveform analysis application 113 may be implemented. In another embodiment, at least a portion of the waveform data analysis may be performed manually without a computer system or software.

A patient record stored in storage device 112 may be processed by the waveform analysis application 113 running on monitor system 111. In one embodiment, the waveform analysis application converts waveform data 216 into a suitable searchable format and stored the converted waveform data such that both waveform data 216 and converted waveform data 218 are stored in patient records 202-206, as shown in FIG. 2A. By doing so, each record 202-206 will contain waveform data 216 suitable for providing waveform images as well as converted data 218 suitable for searching.

There are a number of ways a non-searchable physiological data generated by patient monitoring devices 102 may be converted into a searchable format to enable queries to be performed on the converted data. In one implementation, at least a portion of the non-searchable data is converted into a text format by expressing the non-searchable data in terms of numerical values determined at certain time interval. In another implementation, at least a portion of the non-searchable data (e.g., waveform data) is expressed in terms of a function (e.g., derivative) of waveform data at various time periods.

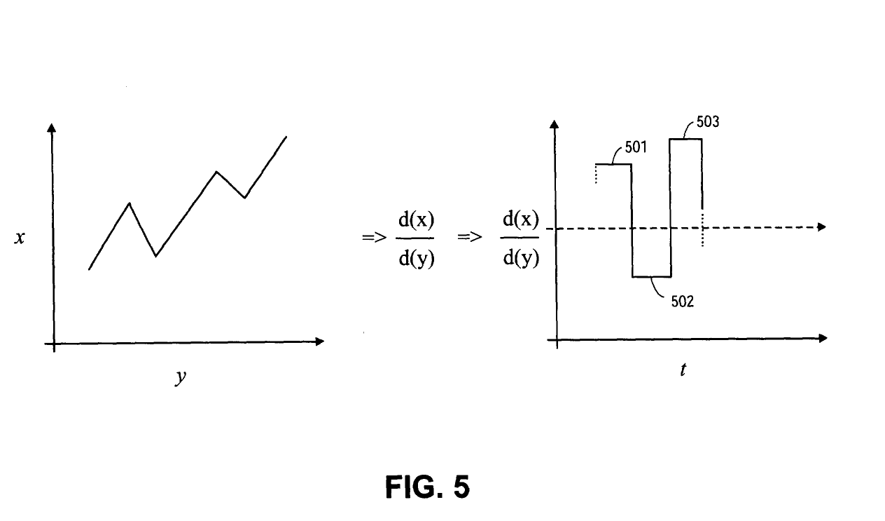

Alternatively or in addition to, pertinent features or patterns relating to the non-searchable data are detected and stored in the corresponding patient record to facilitate subsequent searching. In one embodiment, portions of the waveform data are examined by the waveform analysis application 113 to extract features or patterns that are pertinent to analysis of the waveform data. For example, the waveform analysis application 113 may be configured to recognize certain conditions (e.g., abnormal rhythm on induction) by examining relevant data and when such condition is detected, the waveform analysis application 113 may write an entry in the corresponding patient record indicating the occurrence of such condition and when it occurred. Extracting of pertinent features or patterns of the waveform data can also be accomplished by expressing a function (e.g., derivative) in terms of time and denote specific high points 501, 503 or low points 502 or changes of directions, as shown in FIG. 5.

There are a number of other techniques that may be used to extract pertinent information from the waveform data. For example, pertinent information from the waveform data can be extracted by determining frequency and amplitude of the waveform at various points. The waveform data can also be analyzed by examining each cycle of the waveform, individually. This may be accomplished by capturing a segment of the waveform data that defines a single cycle and analyzing the captured segment, perhaps by applying a suitable algorithm, such as pattern recognition algorithm or transform algorithm.

Alternatively or in addition to, information pertinent to the waveform data may be extracted manually. This may be accomplished by a person who is trained to recognize certain conditions or complications by manually examining the physiological data (including the waveform data). And when certain conditions or complications are noticed by the trained person, such information (i.e., manually extracted data 220) can be manually entered in database 120 along with waveform data 216, as shown in FIG. 2B.

Referring back to FIG. 1, database server 114 also includes a search engine 18 to enable a client computer 16 to perform queries in the database 120 and to retrieve records from the database based on a query request. The query may include a set of instructions for extracting particular record(s) from the database. The query may be expressed in a database query language, such as structured query language (SQL).

For example, the query request may be configured to retrieve records of patients who are older than 13 who had blood pressure drop of greater than 30 points during first 5 minutes of the case. In this case, the first criteria of patient records to be retrieved is “age” and the values which satisfies the query request is greater than 13. And the second criteria of patient records to be retrieved is “blood pressure change during first 5 minutes of the case,” the condition to be satisfied is greater than 30 points. In order to determine if a record satisfies the first criteria, the search engine may examine one of the record files that contains age information and determine if the age value is greater than 13. The determination of whether the second criteria is satisfied involves: (1) accessing the file containing the blood pressure values, (2) retrieving the largest blood pressure value and the smallest blood pressure value within the first five minutes of the case and (3) comparing the largest and smallest blood pressure values to determine if the change is greater than 30 points.

As an another example, the query request may be configured to retrieve records of patients who had abnormal rhythm on induction. In this case, the search engine will go through all patient records contained in the database 120 and identify those records that indicates an occurrence of abnormal rhythm on induction. The determination of whether such condition has occurred may be performed by a software program configured to recognize certain patterns or features within the raw physiological data, as note above.

In response to a query request 122, the search engine 118 will access the database 120 and output a list of patient records 124 that match the conditions specified in the query request. Once the records satisfying the query request have been identified, each individual record may be examined to analyze changes in the physiological condition experienced by the patient while undergoing anesthesia. As mentioned earlier, the patient records also include event information concerning medications that were administered during surgery. In this regard, information regarding administration of medication and its associated time and the physiological changes experienced by the patient before and after the administration of medication may be analyzed to study how certain medication effects certain complication that may arise during surgery.

In one embodiment, the replay application 126 running in the client computer 116 enables a user to trace back to the moment of certain event (e.g., when medication has been administered) and examine physiological changes (such as blood pressure, saturation, heart rate, etc.) taking place in certain time increment. The replay application 126 running in the client computer 116 may also include features to enable the user to zoom in and out of the patient data by either increasing or decreasing the time increment. Furthermore, it should be noted that, by preserving the non-searchable data in its original format, the client computer 116, running the replay application 126, is able to view the non-searchable data (e.g., waveform data) in its intended format (e.g., waveform format).

In accordance with one aspect, the system 100 facilitates retrospective learning by turning learning situations that occurred in the past into learning experiences for those who weren't present at the time the learning situation occurred. For example, a physician may not experience a case where a patient develops arrhythmia (an irregularity in rhythm of the heartbeat) during induction. However, the physician may be trained to more effectively handle such complication by studying and analyzing patient records that indicate occurrence of such complication. By doing so, if similar complication happens to the physician in the future (e.g., next month), the physician will know how to more effective handle the situation. If a physician can retrospectively see a number of cases and see how the abnormal cases were handled, then the physician can be better prepared to handle similar complications.

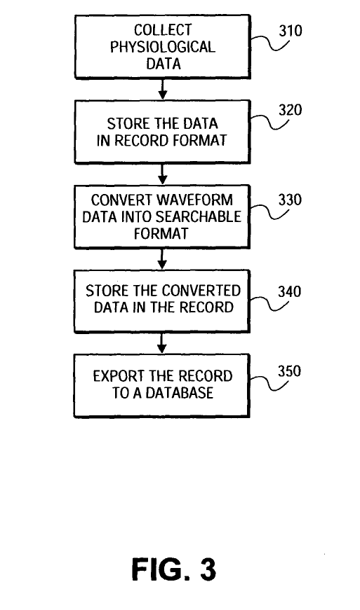

Referring now to FIG. 3, operations of populating a database with physiological data according to one embodiment are shown. In block 310, monitoring devices are used to monitor physiological condition of a patient over a period of time (e.g., while the patient is under anesthesia). The data generated by the monitoring devices is transferred to a storage device that stores the data in a suitable record format for further manipulation in block 320. Once the collection of patient data has been completed, the data contained in the patient record is manipulated to facilitate subsequent searching. In one embodiment, the data in the record that are in a waveform format is converted into a suitable searchable format in block 330. Then in block 340, the converted data is stored in the record along with the waveform data. The record may be exported to a database server containing other patient records in block 350.

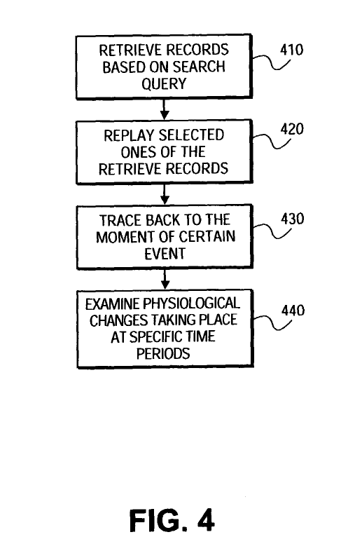

FIG. 4 depicts operations involved in retrospective learning according to one embodiment. The retrospective learning may begin by connecting a client computer to the database server containing a number patient records collected over a period of time (e.g., one month, one year, etc.). The client computer may retrieve patient records from the database server based on a suitable query instruction. For example, if the user of the client computer wants to see how certain complications have been handled in the past. The user can formulate a query request to retrieve patient records that are relevant to such complication. Accordingly, the retrospective learning process begins in block 410, in which the client computer retrieves relevant patient records from the database based on a search query. Then in block 420, the user can initiate the replay application 126 running in the client computer 116 to replay selected ones of the retrieved records. If there are certain events within the patient record that interests the user, the user, using the relay module, can trace back to the moment of the event in block 430. Then in block 440, physiological changes experienced by the patient may be observed by playing the patient data in certain time increment. Further, the user may zoom in and out of the patient data by either increasing or decreasing the time increment. This retrospective learning process can be used to train physicians by turning learning situations that occurred in the past into learning experiences for those who weren't present at the time the learning situation occurred.

While the invention has been described in terms of several embodiments, those skilled in the art will recognize that the invention is not limited to the embodiments described, but can be practiced with modification and alternation within the spirit and scope of the appended claims. The description is thus to be regarded as illustrative instead of limiting.

What is claimed is:

1. A system comprising:
a database to store a plurality of patient records, each patient record including data representing a physiological condition of a patient over a period of time, wherein at least a portion of the data included in the patient record is in a waveform format suitable for providing a waveform image, wherein the patient record further includes data corresponding to at least a portion of the waveform data converted into a searchable format; and
a module coupled to the database to retrieve patient records from database based on a search query and to replay selected ones of the retrieved records.

2. The system of claim 1, wherein the waveform data is converted into a searchable format by expressing the waveform data in terms of numerical values determined at defined time interval.

3. The system of claim 1, wherein the waveform data is converted into a searchable format by detecting a feature contained in the waveform data that is pertinent to a certain physiological condition or complication and making an entry in the patient record indicating an occurrence of such condition or complication.

4. The system of claim 1, wherein the waveform data is converted into a searchable format by expressing the waveform data in terms of a function of the waveform data at various points.

5. The system of claim 1, wherein the waveform data is manually converted into a searchable format by examining the data contained in the patient record, extracting information pertinent to the data, and recording the extracted information in the patient record.

6. The system of claim 1, wherein at least a portion of data contained in the patient records is generated by a plurality of monitoring devices coupled to a patient undergoing anesthesia.

7. The system of claim 1, wherein each patient record comprises physiological data including periodical measurements of heart rate, blood pressure, and oxygen saturation level.

8. The system of claim 7, wherein said physiological data further includes data on end-tidal CO₂ and anesthetic agent identification and concentration, electrocardiogram (EKG) waveform with ST segment analysis, and neuromuscular function.

9. The system of claim 6, wherein each patient record includes a plurality of files, each file containing data from one of the respective monitoring devices.

10. The system of claim 9, wherein each patient record includes information relating to the patient.

11. The system of claim 1, wherein each patient record includes event information concerning medications that were administered.

12. The system of claim 1, wherein module is configured to dynamically display at least a portion of data from the selected ones of the retrieved records in waveform so that changes in certain physiological conditions are readily observable.

13. A database comprising a plurality of patient records, each patient record including data representing a physiological condition of a patient over a period of time, wherein at least a portion of the data included in the patient record is in a waveform format suitable for providing a waveform image, wherein the patient record further includes data corresponding to the waveform data converted into a searchable format.

14. The database of claim 13, wherein at least a portion of data contained in the patient records is generated by a plurality of monitoring devices coupled to a patient undergoing anesthesia.

15. The database of claim 13, wherein each patient record includes event information concerning medications that were administered.

16. The database of claim 13, wherein the waveform data is converted into a searchable format by expressing the waveform data in terms of numerical values determined at defined time interval.

17. The database of claim 13, wherein the waveform data is converted into a searchable format by detecting a feature contained in the waveform data that is pertinent to a certain physiological condition or complication and writing an entry in the patient record indicating an occurrence of such condition or complication.

18. The database of claim 13, wherein the waveform data is converted into a searchable format by expressing the waveform data in terms of a function of the waveform data at various points.

19. The database of claim 13, wherein the waveform data is manually converted into a searchable format by examining the data contained in the patient record, extracting information pertinent to the data, and recording the extracted information in the patient record.

20. A method comprising:
collecting data representing a physiological condition of a patient over a period of time;
storing the collected data in a record, wherein at least a portion of the stored data is in a waveform format suitable for providing a waveform image;
converting the waveform data into a searchable format; and
storing the converted waveform data in the record such that both the waveform data and the converted waveform data are stored in the record.

21. The method of claim 20, wherein the waveform data is converted into a searchable format by expressing the waveform data in terms of numerical values determined at defined time interval.

22. The method of claim 20, wherein the waveform data is converted into a searchable format by detecting a feature contained in the waveform data that is pertinent to a certain physiological condition or complication and writing an entry in the patient record indicating an occurrence of such condition or complication.

23. The method of claim 20, wherein the waveform data is converted into a searchable format by expressing the waveform data in terms of a function of the waveform data at various points.

24. The method of claim 20, wherein the converting the waveform data into a searchable format is performed manually by (1) examining the data contained in the record, (2) recognizing information pertinent to the data, and (3) recording the extracted information in the record.

25. The method of claim 24, further comprising exporting the record to a database containing a plurality of patient records.

26. The method of claim 25, further comprising:
retrieving patient records from the database based on a search query; and
replaying selected ones of the retrieved records.
